(19) United States
(12) Patent Application Publication
(10) Pub. No.: US 2025/0093906 A1
(43) Pub. Date: Mar. 20, 2025

(54) SYSTEMS AND METHODS FOR ACTIVITY TIMING AND SCORING

(71) Applicant: AmpThink, LLC, Garland, TX (US)

(72) Inventor: William C. ANDERSON, III, Garland, TX (US)

(21) Appl. No.: 18/739,110

(22) Filed: Jun. 10, 2024

Related U.S. Application Data
(60) Provisional application No. 63/583,526, filed on Sep. 18, 2023.

(51) Int. Cl. G06F 1/12

(52) U.S. Cl. CPC G06F 1/12

(57) ABSTRACT

An activity timing and scoring system disclosed herein is based on a tightly timed/synchronized data structure that allows for concurrent and accurate collection and distribution of scoring and timing data. The techniques described herein use a precision clock communicated to participating end points using the Precision Time Protocol (PTP) and/or other known or unique time correction algorithms to make one or more system clocks more uniform and to relate one or more game times with a global time.

### RELATED APPLICATION

This application relates to and claims priority from U.S. Provisional Filing Application No. 63/583,526 filed on Sep. 18, 2023 and entitled “Systems and Methods for Event Timing and Scoring.”

### BACKGROUND

Timing and scoring systems are used in conjunction with activities such as ball games, in which events occur, to track events related to a time and to display related data to a human visual interface. In the environment of a sporting event, timing systems typically include a scoreboard and a scoreboard controller. Scoreboard controllers provide a simple interface for capturing game progress (game time, time outs, etc.) and scoring for the purpose of presenting that information. Scoreboards may be metal boxes with fixed programmable digits or more elaborate LED signs with images in place of traditional “Visitor” and “Home” concepts.

Such scoreboard controller systems are simple and leverage onboard timing solutions that are simple and lack precision. Additionally, the scoreboard controller systems lack integration with other critical systems, which could benefit from scoreboard controller information or which could support and improve the scoreboard controller system. which can include cloud repositories of timing and scoring date, solutions that allow for monetization of scoreboard content, clocks for game progress presentation, and systems to synchronize all of these systems on a common clock or in a database.

Currently, a number of techniques utilize cloud-based controllers or tablet-based controllers that are meant to replace the traditional scoreboard controller infrastructure. However, none of these systems solve a basic problem of system integration or concurrency. Event systems that provide some level of concurrent data distribution do so in an uncoordinated way that does not ensure correct timing across multiple events where the timing of each event corresponds to a standardized “real” or “global” time.

### SUMMARY

An activity timing and scoring system disclosed herein is based on a tightly timed/synchronized data structure that allows for concurrent and accurate collection and distribution of scoring and timing data. The techniques described herein use a precision clock communicated to participating end points using the Precision Time Protocol (PTP) and/or other known or unique time correction algorithms to make one or more system clocks more uniform and to relate one or more game times with a global time.

The techniques described herein may be used in conjunction with a single-activity context or a multi-activity environment. In a single activity context, it may be desirable to display an accurate activity clock and/or real time clock in various viewing venues, such as arena concession stands, restaurants, private suites, etc. Also, it would be desirable to record events that occur during an activity in relation to real time rather than an activity time, enabling analysis of multiple activities vis-à-vis when certain events occurred in each activity.

In a multi-activity context, the techniques described herein can be used correlate events in different activities with a common time (e.g. real time, etc.) or clock. In some contexts, such as with sports betting, it is desirable to know the exact time an event or activity occurs, such as when a game officially starts. If no common time is utilized, then the record only shows that a game event (e.g., a start time) that occurred at a certain time reflected on a computer clock or even a spectator's watch. This environment does not provide the accuracy and security needed by sports analysts to conduct their research or business.

A further aspect of the present disclosure is that one or more limited-function controllers (LFC) can be used at an activity, in person or remotely. Each limited-function controller is controlled by a person, and that limited-function controller is operated by the person to enter a subset of events, that subset of events being a subset of the universe of possible events that may be tracked in an activity. For example, a person operating a main controller at a high school basketball game might use the main controller to enter when a score is made. At the same time, a parent or another person parent sitting in the stands of the game might use an LFC to track the identities of players who made a score. The inputs are correlated and synchronized by the main controller.

A further aspect of the present disclosure is a technique of using a configurable interface to alter a scoreboard controller interface to correspond to the type of activity. For example, if the activity is “Basketball,” then a soft keyboard or a keypad with configurable labelling would have entries corresponding to a game of basketball, such as a number of periods, length of a period, timeouts used/remaining, shot clock start/stop, etc. Each activity may also have subsets associated therewith. In the context of a basketball game, a scoreboard controller is further configurable to distinguish between NBA rules (4 periods of 12 minutes, shot clock=24) and NCAA rules (2 periods of 20 minutes, shot clock=35). Rule sets accessible by the scoreboard controller correspond with each type of activity capable of being operated. A selection of a rule set would automatically configure a scoreboard controller interface to correspond to the activity represented by the rule set.

### BRIEF DESCRIPTION OF THE DRAWINGS

A particular description of the principles briefly described above will be rendered by reference to specific embodiments thereof, which are illustrated in the appended drawings. Understanding that these drawings depict only certain example embodiments of the disclosure and are not therefore to be considered to limit its scope, the principles herein are described and explained with additional specificity and detail through the use of the accompanying drawings.

FIG. 1 is a depiction of an example activity timing system environment in which the techniques described herein may be implemented.

FIG. 2 is a depiction of an example of a local controller that may be implemented in one or more of the techniques described herein.

FIG. 3 depicts an example database suitable for use with the techniques described herein.

FIG. 4 depicts an activity timing cloud environment in accordance with the techniques described herein.

FIG. 5 depicts a distributed activity timing network in accordance with the present description.

FIG. 6 depicts a particular implementation of an activity timing system in a baseball multi-field complex.

FIG. 7 is a flow chart depicting a general process for use in an activity timing system as described herein.

FIG. 8 is a flow diagram of one method of calculating a messaging system latency to synchronize one or more timing devices.

### DETAILED DESCRIPTION

The apparatuses and techniques described herein relate to an activity timing and scoring system that allows for concurrent and accurate collection and distribution of scoring and timing data. The techniques described herein use a precision clock communicated to participating end points using time correction techniques to make one or more system clocks more uniform and to relate one or more game times with real time.

One or more implementations provided herein utilize methods that capture the causality relationship of events that occur in time keeping systems. Similar applications of these theories have been made in computer science with so-called “logical clocks” that track events that occur in distributed systems related to system devices and databases. Rather than order events according to time (because clocks usually differ between devices) events are ordered according to what happened first. Logical clocks introduced the idea of causality tracking as an abstraction for reasoning about concurrency between events in the system.

Logical clocks, however, do not solve the issues encountered with correlating activity events with a global time. As a solution to that, “hybrid logical clocks” were developed. Hybrid Logical Clocks (“HLC”) are extensions of the previous causality and time keeping systems that capture the causality relationship like logical clocks, but that can also substitute for physical clocks by maintaining its logical value always close to Network Time Protocol (“NTP”). NTP is a networking protocol for clock synchronization between computer systems over packet-switched, variable-latency data networks. HLC can be used in lieu of a physical clock source like NTP for device reads and writes, and it can simultaneously be used as a logical clock to identify consistent global snapshots of when certain events occur.

One or more implementations described herein may also utilize time resources such as Global Positioning System (“GPS”) time, where devices are synchronized using a reference GPS time signal. Additionally, implementations herein can utilize the Precision Time Protocol (“PTP”) method as a timing resource. According to John Eidson, the leader of the PTP standardization effort, PTP is designed to fill a niche not well served by either of the dominant protocols, NTP and GPS. PTP is designed for local systems requiring accuracies beyond those attainable using NTP. It is also designed for applications that cannot bear the cost of a GPS receiver at each node or device, or for which GPS signals are not accessible.

As referred to herein, an “activity” is an occurrence of something that takes place where ordered events occur, and wherein the activity includes a timing aspect. The present discussion primarily relates to activities that are sporting events, such as games (basketball, football, soccer, etc.). An activity may also be an individual activity that is timed, such as a track runner or a swimmer being timed for certain distances. Although the present disclosure deals primarily with sporting events, or games, the disclosed techniques may also be utilized in any context where recording the exact (or near-exact) global time for an event that occurs within an activity, those skilled in the art will recognize similar applications of the present techniques.

Current scoreboards for sports games utilize scoreboard controllers that are typically simple and leverage onboard timing solutions that are simple and lack precision. Work has been done to develop cloud-based controllers or tablet-based controllers that replace the traditional scoreboard controller. But these systems have not solved the basic problem of system concurrency. The cloud/tablet-based systems provide some level of concurrent data distribution but do so in an uncoordinated way. Even if such a distributed system provides some level of concurrent data distribution, they do so in an uncoordinated manner. The nodes in such distributed systems are disconnected and often require integration to interoperate properly. The techniques described herein are meant to systemically solve the problems of concurrency and integration.

The timing and scoring solutions described herein are based on a tightly timed/synchronized data structure that allows for concurrent and accurate collection and distribution of scoring and timing data. The solution moves beyond current game clock timing and leverages a precision clock communicated to participating end points using the precision timing protocol (PTP) and/or other correction algorithms to ensure that data collection and presentation is properly aligned with pace of play.

By enrolling data collection devices in the system, these devices can deliver scoring or event data and integrate the data into a timeline. Each data input-regardless of origin is accurately stamped with the specific time of collection and relative to all other inputs. At the same time, this data can be manually adjusted to account for external factors, such as field of play decisions. For example, the systems can record the occurrence of a penalty via a remote input device that is in the possession of a referee. The referee may provide a simple signal that a penalty occurred. The same data may be amended by a third party using a sperate interface and that third party may even adjust the time of the penalty to align with their own observation of the penalty where the referee may have signaled late. This can be done without deleting the timing of the referee's signal for preservation of the integrity of a review process.

Data capture events can then be augmented as they are presented on a timeline with additional data that is tied to an event concept. At all times, the data stream is available to all endpoints with precision timing information-corrected to address network latency-allowing for concurrent consumption and presentation on the scoreboard, in an app, on a TV, via a video wall, or even via a legacy clock.

The systems disclosed herein are based on a common database (timeseries, relational, non-relational or otherwise) that is distributed. The database relies on common database conventions for concurrency. Data is placed in a primary data repository that replicates to other repositories automatically. Data entry may be driven to the primary database or secondary or tertiary sources as allowed by available network transport where the database handles replication and synchronization.

As will be described in further detail below, event data that is captured is timestamped. Ahead of assigning timestamps, systems will determine an inter-system latency to determine timing differentials attributable to network latency and assign correction values for system timestamps. These corrections can include both micro corrections (accounting for millisecond differences caused by network latency/congestion) and macro adjustments (time zones).

The systems described below rely on a common command set that can update the database. The command set can be a programmatic interface that allows for transaction insertion and update. The commands are typically transported over industry standard secure transport (for example Hyper-Text Transfer Protocol (https)). The command structure is extensible and may be appended over time as individual use cases require. For brevity, all command sets detail the command elements to allow for the transport of the minimum set of relevant data per transaction. Compression or mapping techniques may also be applied to ensure compact packet sizes that are optimized for time sensitive transactions.

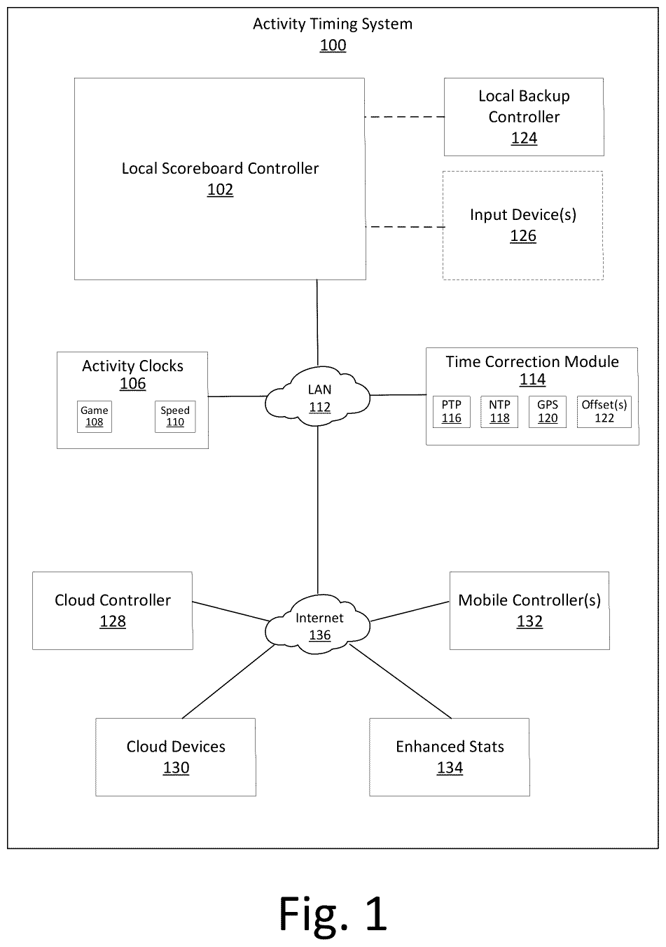

The features and techniques broadly stated above are described in greater detail, below, with respect to FIGS. 1 through 8. The following description of the figures incorporates the functional aspects of the described systems depicted above.

FIG. 1 is a depiction of an example activity timing system 100 in which the techniques described herein may be implemented. Although components are shown configured in a particular relationship, it is noted that one or more of the components shown in FIG. 1 may be implemented differently or, in some cases, not at all. Components may be located in a different location than shown in FIG. 1. For example, a time correction module may be stored internally in a local scoreboard controller or it may be stored remote from the local scoreboard controller, where it can be accessed and utilized by the local scoreboard controller.

The example activity timing system 100 includes a local scoreboard controller 102 that is situated at the site of an activity such as a basketball game. Discussion of later figures will show that a scoreboard controller may also be operated remotely from an activity site. The example activity timing system 100 also includes one or more activity clocks 104, such as one or more of a game clock 106 and a speed clock 108 (e.g. shot clock, play clock, etc.). The activity clocks 104 may be accessed by the local scoreboard controller 102 by way of a local area network 112, or the activity clocks 104 may be located onboard the local scoreboard controller 102.

The example activity timing system 100 also includes a time correction module 114 that accesses one or more sources of a baseline time, such as Precision Time Protocol (PTP) 116, Network Time Protocol (NTP) 118, and/or Global Positioning System time (GPS) 120. An offset 122 is shown stored with the time correction module 114 and it used to store a delay time that is used to adjust time recording for activity events.

The example activity timing system 100 may also include a local backup controller (124) that may be used in case of failure of the local scoreboard controller 102. Input devices 126 for the example activity timing system 100 may be used to input one or more events to the local scoreboard controller 102. One of more of the input devices 126 may be included with the local scoreboard controller 102 but, as will be discussed in greater detail below, multiple external or remote input devices 126 may be utilized in the presently described techniques. The input devices 126 may include a full array of event entry buttons (not shown), or discrete input devices 126 may have only one or few event entry buttons that combine to provide the full array of event entry buttons.

The example activity timing system 100 as described thus far may be sufficient for some scenarios, such as a single activity site, e.g. a basketball court. But there are many scenarios that require a more extensive and distributed activity timing system. For such scenarios, the example activity timing system 100 may also include a cloud controller 128, one or more cloud devices 130, one or more mobile controllers 132, and/or an enhanced statistics module 134. All of these components are accessible by way of the Internet 136 or a wide area network (not shown). The cloud controller 128 is similar to the local scoreboard controller except it is not located on the premises of an activity. The cloud controller 128 may be accessed by the local input devices 126 to record activity events as described herein. The cloud devices 130 include devices that are located remote from the activity site, such as input devices, data recording devices, video devices, monitoring devices, and the like.

The mobile controllers 132 are mobile electronic devices that include the functionality of a full or partial scoreboard controller. Such devices may include phones, tablets, laptop computers, etc. Any functionality that can be configured in the local scoreboard controller 102 may be implemented on one or more of the mobile controllers 132.

FIG. 1 illustrates the various and multiple opportunities that are present to introduce latency into an activity timing system. Every device connection can introduce some level of latency. There is message latency associated with the communication of every device with the LAN 112 and/or with the Internet 136. There are latencies associated with processing that occurs in each component. The techniques illustrated and described herein are intended to measure such latencies and correct activity timing systems to account for the latencies.

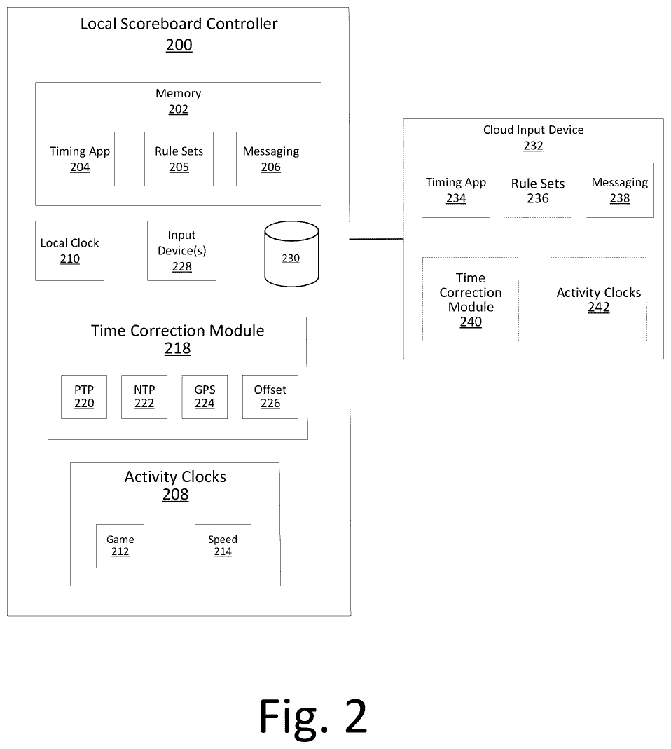

FIG. 2 is a depiction of an example of a local scoreboard controller 200 that may be implemented in one or more of the configurations described herein. The local scoreboard controller 200 is similar to the local scoreboard controller 100 shown in FIG. 1. The local scoreboard controller 200 includes memory 202 that stores a timing application 204, a rule sets module 205, and a messaging application 206. The timing application 204 is configured to determine a correction to be made to one or more activity clocks 208 so as to determine a time of an activity event closer to a global time rather than a game time. The messaging application 206 is configured to send and receive messages, process messages, and apply a timestamp to the time a message was received and/or sent, and a time taken to process a message. A timestamp applied by the messaging application 206 is based on a local time provided by a local clock 210 associated with the local scoreboard controller 200. The timestamping process and how it is used to derive an adjustment for the local clock 210 is described in greater detail below.

The rule sets 205 allows a controller interface to be selected from a group of controller interfaces to suit a specific activity. This allows an appropriate interface to be easily changed for different applications and/or activities. For example, selection of a college basketball game would enable variable components of the interface to correlate to NCAA rules for basketball. If a subsequent activity is a high school basketball game, then an appropriate interface would be easily selectable that would enable high school basketball rules to be applied to the variable components of the interface. Such an interface can feature soft components (i.e., a soft keyboard) or physical components, such as with a standard scoreboard controller entry panel, or a combination thereof.

The activity clocks 208, as shown, include a game clock 212 that is used to time a game or other activity, and a speed clock 214 that is used to time certain shortened rate of play periods in a game or other activity (such as a play clock, a shot clock, a pitch clock, etc.).

A time correction module 218 is included in or with the local scoreboard controller 200, and includes one or more forms of determining a global time. As shown, the time correction module 218 includes a PTP component 220, an NTP component 222, a GPS component 224, and an offset 226, which indicates a network latency time that may be used to adjust on or more of the activity clocks. Although shown as being stored in the time correction module 218, the offset 226 may be stored in any practical location accessible by the timing application 204. The timing application 204 may use the offset 226 in lieu of recalculating a previously derived network latency, or it can be used in other ways to adjust the activity clocks 208.

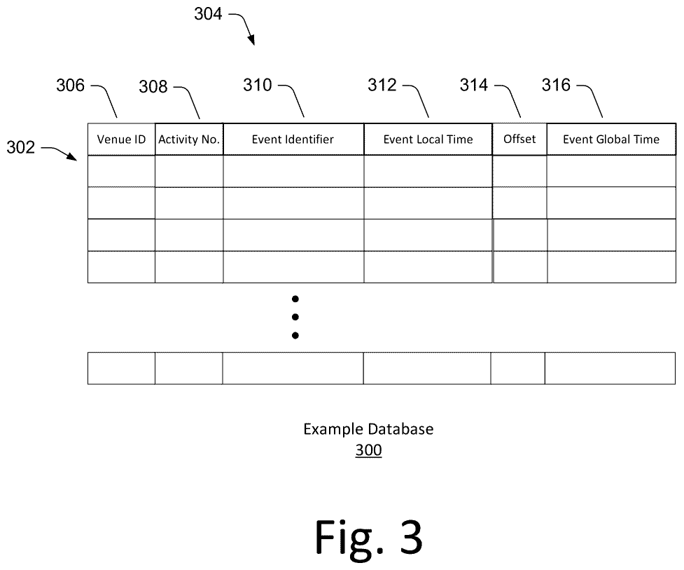

The local scoreboard controller 200 also includes one or more input devices 228 and a local database 230. The local database 230 is shown and described in more detail with respect to FIG. 3, below. The input devices 228 may be physically or wirelessly connected to the local scoreboard controller and can take a number of forms. Input devices 228 include devices such as cell phones, tablets, and proprietary controllers that can transmit scoring, timing, or other game play event data over a wired or wireless network. Each input device 228 can generate a time stamp and insert that stamp into a command packet for transmission to the messaging module 206. Input devices 228 can be as simple as a single button mapped to a single command corresponding to a single activity event, or include complex data entry methods that a user or other machine-based system can populate.

A cloud input device 232 is shown in communication with the local scoreboard controller 200. The cloud input device 232 includes a timing application 234, rule sets 236, and a messaging module 238. The timing application 234, rule sets 236, and a messaging module 238 include the same components as their similarly-named counterparts in the local scoreboard controller 200. However, the timing application 234, rule sets 236, and a messaging module 238 of the cloud input device 232 may supplant in full or supplement in part the counterparts in the local scoreboard controller 200. Depending on the implementation, different configurations of the local scoreboard controller 200 and the cloud input device 232 may be used and functions may be distributed between the local scoreboard controller 200 and the cloud input device 232.

An input device 228 may also be a sensor-based device that requires no human interaction. Example include boundary cameras (soccer, tennis, etc.), goal sensors (hockey, basketball, etc.), or speed sensors (cars, balls, players, etc.). In addition, an input device 228 may be an attachable sensor worn by a player or attached to a piece of game equipment. A weather sensor (not shown) may also be a type of input device 228 that provides data related to the weather at an activity, such as a horse race. In addition to the foregoing, data may be collected from external input devices 228 that monitor events not integrally related to the activity. For example, an input device 228 may provide an input as to network traffic related to specific times of the activity, or may be used to provide concession stand data (sales, customers, etc.) related to specific times of the activity. Implementations included the latter can be used to analyze peripheral events that occur during an event and that can be adjusted to provide improved service based on the times that certain events occur.

The presently described techniques may be used to replace manual data collection inputs with machine-based inputs to reduce game and system errors and inaccuracies. For instance, if a baseball umpire is replaced by an electronic system as described herein, a much more extensive set of data can be collected for instantaneous game feedback or for post-event review (e.g., replay), or for post-activity review to train systems and verify accuracy. Collecting event data from a great many sensors would provide much more as far as quantity and dimension that can be captured by a human.

FIG. 3 depicts an example database 300 suitable for use with the techniques described herein. The example database 300 includes multiple records 302. Each of the multiple records 302 is associated with an event that occurs during an activity. For instance, an event could be a score in a game, a start time, a finish time, a time that a penalty is called, etc. Each record 302 has a number of fields 304 contained therein. The number and contents of the fields 304 can vary between different implementations. In the example database 300 shown in FIG. 3, each record 302 includes a venue identifier field 306, an activity number field 308, an event description field 310, an event local time field 312, an offset field 314 and an event global time field 316. The venue identifier field 306 stores a value that uniquely identifies an activity venue. A timing system used in a single venue may forego this field, but the venue identifier field 306 makes it possible to store activity event data from across a number of venues. The activity number field 308 stores a value that uniquely identifies a particular activity, such as a certain game in a season.

The event description field 310 stores an activity event description or identifier that identifies a particular event that occurs in an activity. Events for different types of activities are standardized, so this field may simply contain a number that corresponds to a particular event. The event local time field 312 stores a value that identifies a local time at which the event identified in the event description field 310 occurred. The offset field 314 stores a clock offset calculated to correct the event local time 312. The event global time field 316 stores a value that identifies a global time (or near-global time) that corresponds with the value stored in the event local time field 312. The event global time field 316 is a corrected value of the local time, which is associated with a clock associated with a local scoreboard controller.

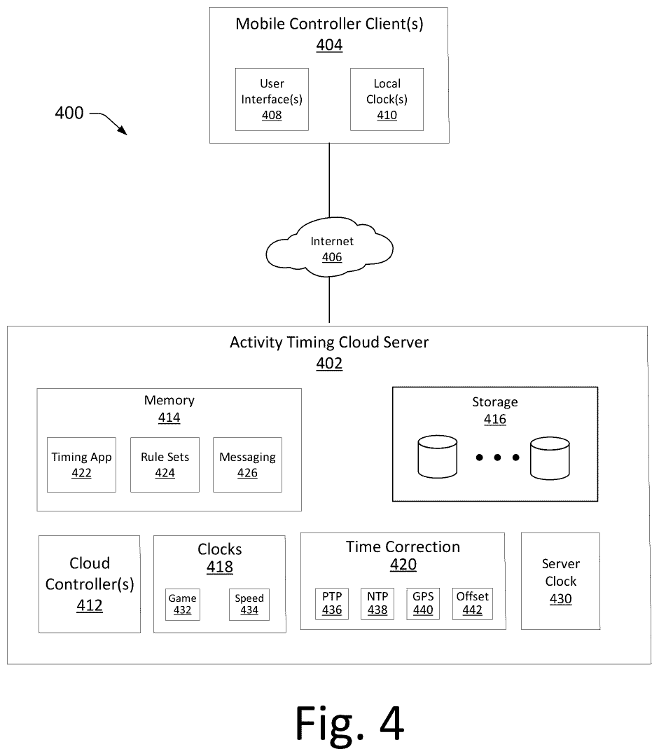

FIG. 4 depicts an example of an activity timing cloud environment 400 as described herein. The activity timing cloud environment includes an activity timing cloud server 402 that communicates with one or more mobile controller clients 404 by way of a wired or wireless network, such as the Internet 406. Each of the one or more mobile controller clients 404 includes a user interface 408 through which a user accesses controller functions in the cloud. Each mobile controller client 404 includes an internal clock 410 and a messaging system 412 with a timestamp capability similar to those shown in and described with respect to previous figures.

The activity timing cloud server 402 includes one or more cloud controllers 412 that function similarly to the scoreboard controllers previously described herein. The activity timing cloud server 402 also includes memory 414, storage 416, a clocks module 418 and a time correction module 420. The memory 414 includes a timing application 422, rule sets 424, and a messaging component 426. The timing application 422 is configured to determine a correction to be made to one or more activity clocks 418 so as to determine a time of an activity event closer to a global time rather than a game time. The messaging application 426 is configured to send and receive messages, process messages, and apply a timestamp to the time a message was received and/or sent, and a time taken to process a message. A timestamp applied by the messaging application 426 is based on a local time provided by a server clock 428 associated with the activity timing cloud server 402.

The rule sets 424 allows a controller interface to be selected from a group of controller interfaces to suit a specific activity. This allows an appropriate interface to be easily changed for different applications and/or activities. For example, selection of a college baseball game would enable variable components of the interface to correlate to NCAA rules for baseball. If a subsequent activity is a high school soccer game, then an appropriate interface would be easily selectable that would enable high school soccer rules to be applied to the variable components of the interface. Such an interface can feature soft components (i.e., a soft keyboard) or physical components, such as with a standard scoreboard controller entry panel, or a combination thereof.

The clocks module 418 store clocks necessary for the operation of activities. In the present example, the clocks module includes a game clock 432 and a speed clock 434. The time correction module 420 accesses one or more sources of a baseline time, such as Precision Time Protocol (PTP) 436, Network Time Protocol (NTP) 438, and/or Global Positioning System time (GPS) 440. An offset 442 is shown stored with the time correction module 420 and it used to store a transaction delay time that is used to adjust time recording for activity events.

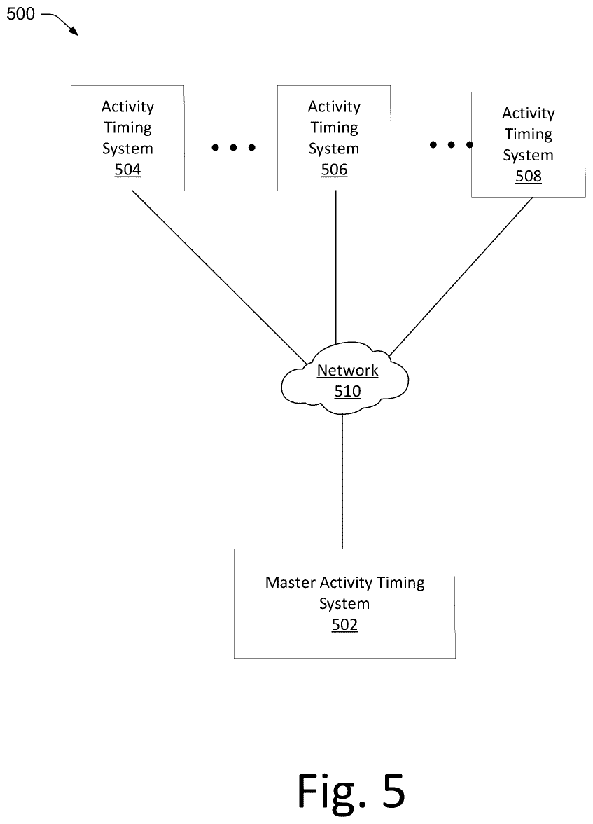

FIG. 5 depicts a distributed activity timing network 500 in accordance with the present description. The distributed activity timing network 500 includes a master activity timing system 502 and a plurality of activity timing systems 504, 506, 508 that are similar to the activity timing systems previously described herein. The master activity timing system 502 communicates with the activity timing systems 504, 506, 508 through the Internet 510. Although the master activity timing system 502 is shown communicating with the activity timing systems 504, 506, 508 through the Internet 510, it is noted that the master activity timing system 502 and the activity timing systems 504, 506, 508 may communicate by way of a local network (such as a school campus that has various activity sites on campus) or a wide area network, such as in an organization that has various activity sites located a significant distance from each other but that are connected through their own wide area network, such as a university system that has separate campuses.

The distributed activity timing network 500 allows activity timing systems to operate in disparate locations, but with various components at different locations. The activity timing systems 504, 506, 508 can operate using one or more components located in the master activity timing system. As an example, a time correction module may not be included in activity timing systems 504, 506, 508, but may be run by way of a time correction module (not shown) in the master activity timing system.

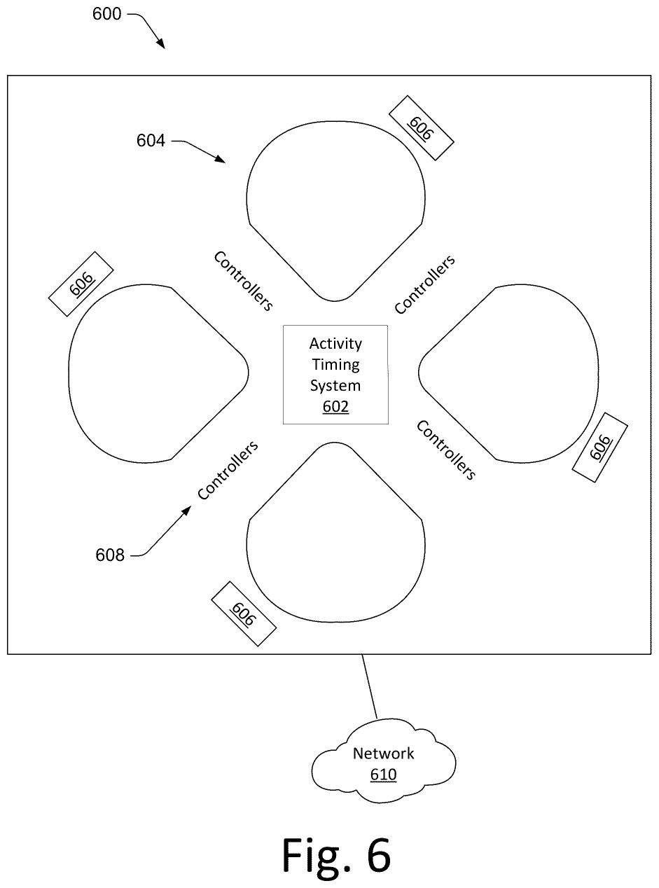

FIG. 6 depicts a multi-field baseball complex 600 in which a particular implementation of an activity timing system 602 is situated. The baseball complex 600 includes a plurality of baseball fields 604 on which multiple baseball games may be played simultaneously. The activity timing system 602 is similar to the systems shown in FIG. 1 and FIG. 2, and services each of the plurality of baseball fields 604. A scoreboard 606 is positioned adjacent to each baseball field and each scoreboard 606 is controlled through the activity timing system 602. The activity timing system 602 includes multiple scoreboard controllers 608. Although as many as four local scoreboard controllers may be included in the activity timing system 602, they are not shown in FIG. 6. The multiple scoreboard controllers 608 are shown dispersed throughout an area of spectator stands, where each can be operated by a spectator. Although the multiple scoreboard controllers 608 may be complete controllers, more often they will be Limited Function Controllers (LFC) that each control a finite number of event entries, the finite number of event entries being a subset of the universe of event entries associated with a local controller. The activity timing system 602, scoreboards 606, and controllers 608 communicate with a network 610, which can be a local network or the Internet.

The environment of the activity timing system 602 allows for time correction of multiple baseball games (activities) so that all games timed with the activity timing system 602 are synchronized to the same clock, and the clock is approximately a global or universal time, such as UTC. Recording event data from each of the games played with the activity timing system 602 allows that event data to be analyzed and compared to similar event data from the same or different location.

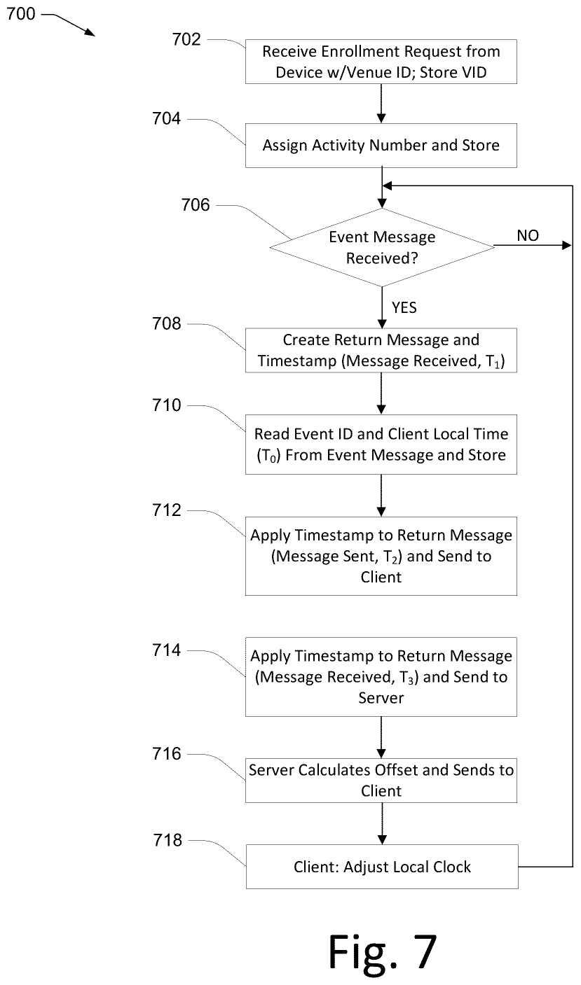

FIG. 7 is a flow chart depicting a general process flow 700 for use in an activity timing system as described herein. In the following discussion of process flow 700, reference is made to previous figures using reference numbers included therein. In particular, the following discussion outlines an implementation in the activity timing system 100 shown in FIG. 1, and the local scoreboard controller 200 shown in FIG. 2. Although the general process flow 700 is shown having particular steps, it is noted that the actions performed in each step may be performed in a different step or in a different sequence than shown without departing from the scope of the claims.

The implementation shown in FIG. 7 depicts most time correction activities occurring at the local scoreboard controller 200 (FIG. 2) (referred to in FIG. 7 as a “Server”) and some such actions occurring at the cloud input device 232 (FIG. 2) (referred to in FIG. 7 as “Client”). However, any actions of a step attributed to a particular component of a particular system may, in practice, be accomplished by other components and/or other systems without departing from the scope of the claimed invention.

At step 702, the local scoreboard controller 200 (FIG. 2) receives an enrollment request from the cloud input device 232 and reads a venue identifier 306 (FIG. 3) from the request and stores the venue identifier 306 in a database 300 (FIG. 3). The local scoreboard controller 200 assigns an activity number to the cloud input device 232 at step 704 and stores it in the activity number field 308 (FIG. 3) in the database 300.

At step 706, the local scoreboard controller 200 monitors whether the connected device has sent an event message. If not (“No” branch, step 706), then the monitoring continues. In at least one implementation, a timeout may be used to terminate a connection if no messages are received after a certain time. If an event message is received from the connected device (“Yes” branch, block 706), then messaging module 206 (FIG. 2) creates a return message and applies a local clock timestamp (T₁) to the return message at step 708.

At step 710, The messaging module 206 reads an event identifier and stores it in the event identifier field 310 (FIG. 3) of the database 300. Also, the client local time that the event message was sent (T₀) is read from the event message and stored in the event local time field 312 of the database 300. At step 712, the messaging module 206 applies a time stamp (T₂) and transmits the return message to the cloud input device 232.

At step 714, the cloud input device 232 applies a timestamp (T₃) to a new message (message received by client) and sends the message to the local scoreboard controller 200. The timing application 204 (FIG. 2) of the local scoreboard controller 200 now has the information it needs to determine a latency due to network transmission delay and message processing delay. Details of that determination are provided below.

The timing application 204 calculates an offset 226 (FIG. 2) and transmits the offset 226 to the cloud input device 232 (step 716). The timing application 204 also stores the offset 226 locally. At step 718, the cloud input device 232 utilizes the offset 226 to adjust its local clock 239 (FIG. 2). The cloud input device 232 then sends the offset to the local scoreboard controller 200 where it is stored in the offset field 314 of the database 300. The local scoreboard controller 200 may utilize the offset 226 to adjust its interactions with the cloud input controller 232.

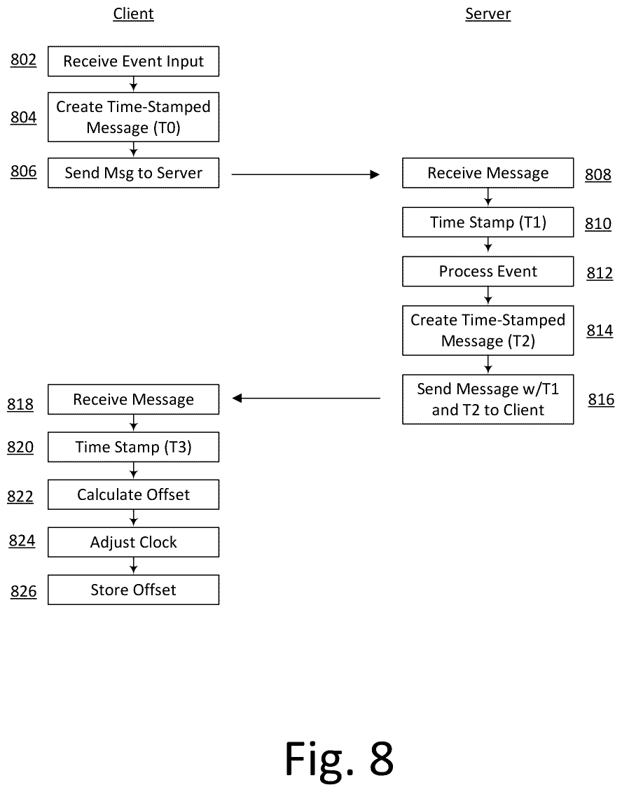

FIG. 8 is a flow diagram 800 of one method of calculating a messaging system latency to synchronize one or more timing devices. In the following discussion of FIG. 8, continuing reference is made to elements and reference numbers shown in previous figures. Although the flow diagram 800 is shown having particular steps, it is noted that the actions performed in each step may be performed in a different step or in a different sequence than shown without departing from the scope of the claims.

In contrast to the flow chart 700 shown in FIG. 7, the flow diagram of FIG. 8 is shown with steps occurring at the server (the local scoreboard controller 232) and at the client (the cloud input device 232). The allocation of tasks is different in FIG. 8 than in FIG. 7, as there are a number of different configurations that may be implemented. In the flow diagram 800 of FIG. 8, for instance, the offset calculation is handled by the client 232 rather than the server 200.

At step 802, the client 232 (assumed to be already enrolled with the server) receives a signal indicating an input event. Such a signal comes from a user interface of the device, when a user engages an actuator to indicate that a particular event has occurred. In the present example, each event has a different user interface actuator (not shown) so that pressing a particular actuator indicates a particular event has occurred.

At step 804, the client 232 creates a message and timestamps the message with a local time that the client 232 transmits the message to a server 200. The time indicated in the timestamp is To. The client 232 then sends the message to the server 200 at step 806. Although referred to as different steps, the timestamp occurs simultaneously with the message transmission.

At step 808, the server receives the message and timestamps the message with a server clock time at step 810. This timestamp is T₁. The server processes the event at step 812 by storing event data contained in the message in the database 300 (FIG. 3). At step 814, the server creates a time-stamped message that includes T₁ and the time that the message is transmitted to the client (T₂) (step 816).

At step 818, the client receives the message and timestamps the message with the local time the client received the message (T₃) at step 820. At step 822, the client calculates an offset 226 to determine the latency introduced by the system. The client uses the offset to adjust the client's local clock at step 824. At step 826, the client stores the offset 226 and sends the offset 226 to the server 200 where it is stored in the database 300 (FIG. 3).

### Time Correction

One particular implementation of a time correction algorithm that may be used with the techniques described herein is based on the above-described processes where the server and/or the client have access to T₀, T₁, T₂, and T₃. Based on these times, the following can be calculated:
The amount of time it took the client to process the event from start to finish (DC=T₃−T₀).
The amount of time it took the server to process the event (DS=T2−T₁).
The round-trip network delay can be found: RTT=DS−DS.
The one-way network delay can be assumed to be approximately half of RTT(ND=RTT/2)
The offset can be derived by taking max (T₁−T₀, T₃−T₂)−ND.

Once the offset has been found, the client local clock can be corrected to minimize the clock different between the server clock and the client clock. There are a number of formulas that may be used for doing this that are known in the art. As the client continues to send the offset 226 to the server 200, the server 200 can keep track of the offset 226 of each client 232 and possibly adjust its behavior or replies to the client 232 based on the offset 226.

While the invention is described with respect to certain embodiments and/or generally associated methods, alterations and permutations of these embodiments and application to any application, a person having ordinary skill in the art will recognize other applications in which the presently described paint mask assembly may be used. Accordingly, the above description of example embodiments does not define or constrain this disclosure. Other changes, substitutions, and alterations are also possible without departing from the spirit and scope of this disclosure, as defined by the following claims.

1. A timing system controller, comprising:
a processor;
computer-readable memory, that stores a data store having multiple records, each record having at least an event description field, an event time field, and a real time field;
a clock that defines event time;
input means to receive event metadata related to an event, the event metadata including at least an event description and an event time;
a synchronization module configured to derive a real time that corresponds to the event time;
storing means for storing:
the event description in the event description field of a data store record;
the event time in the event time field of the data store record;
the real time in the real time field of the data store record.
